(19) United States
(12) Patent Application Publication
(10) Pub. No.: US 2007/0155502 A1
(43) Pub. Date: Jul. 5, 2007

(54) DEVICE FOR MOTION TRACKING AND OBJECT FOR REFLECTING INFRARED LIGHT

(75) Inventor: Meng Tsung WU, HSIN-CHU (TW)

Correspondence Address: LOWE HAUPTMAN BERNER, LLP, 1700 DIAGONAL ROAD, SUITE 300, ALEXANDRIA, VA, 22314, US

(73) Assignee: PIXART IMAGING INC., HSIN-CHU COUNTY (TW)

(21) Appl. No.: 11/466,714

(22) Filed: Aug. 23, 2006

(30) Foreign Application Priority Data
Dec. 16, 2005 (TW) 094144633

(51) Int. Cl. A63F 13/00

(52) U.S. Cl. 463/37

(57) ABSTRACT

A device for motion tracking includes at least one object for reflecting light, an optical signal transmitting/receiving unit and a calculating/processing unit. The object includes a surface, a first reflecting pattern and a second reflecting pattern, wherein the first reflecting pattern and the second reflecting pattern are respectively located on the surface, and the first reflecting pattern is different from the second reflecting pattern. The optical signal transmitting/receiving unit transmits infrared light and receives the infrared light reflected by the object so as to form a plurality of pixel signals. The calculating/processing unit is electrically connected to the optical signal transmitting/receiving unit for calculating and processing the correlative pixel signals.

This application claims the priority benefit of Taiwan patent application serial no. 094144633, filed Dec. 16, 2005, and the full disclosures thereof are incorporated herein by reference.

### BACKGROUND OF THE INVENTION

1. Field of the Invention

The present invention generally relates to an object for reflecting infrared light, and more particularly, to a device for motion tracking, wherein the device includes at least one object for reflecting light, and the object includes two different reflecting patterns.

2. Description of the Related Art

With the prevalence of the video/audio multimedia, there is a tendency toward the digitization of image gradually. Conventional image sensors, such as infrared light receiving elements, are gradually applied to the field of interactive game apparatus.

Referring to FIGS. 1a and 1b, U.S. Patent Publication No. 2003/003417, entitled “Soccer Game Apparatus”, discloses that a soccer game apparatus 10 includes a game processor disposed therein, and the game processor allows at least one soccer player to be displayed on the screen 12. A signal outputting device 20 is attached to a player's leg 22. When the player moves his leg 22, correlative acceleration signals are outputted from the signal outputting device 20. For example, the game apparatus 10 is provided with an infrared light-receiving portion 14, and the signal outputting device 20 is provided with an infrared light emitting diode (LED), wherein the infrared light-receiving portion 14 receives infrared signals generated from the infrared light emitting diode (LED). Thus, the game apparatus 10 receives the correlative acceleration signals formed by the infrared signals, whereby the game apparatus 10 processes the correlative acceleration signals so as to cause the soccer player to be changed on the screen 12. However, the signal outputting device must be attached to the player's leg, and thus the weight of the signal outputting device is a burden on the player's leg. Furthermore, the signal outputting device is easily damaged because it is often shaken together with the player's leg, and thus the lifetime of the signal outputting device is relatively short.

In additional, referring to FIG. 2, currently there has been a baseball game apparatus 50 to be put on the market, and the baseball game apparatus 50 is provided with an image sensor of low resolution and a processor. When a player 56 brandishes a bat 52, the image sensor is adapted to detect the signals reflected by single detecting point 54 located on the surface of the bat 52, and the processor is adapted to process the signals and output the track of motion of the detecting point 54 of the bat 52. However, the surface of the bat is only provided with a single detecting point, and thus the process only outputs the track of motion of the detecting point of the bat. The process cannot output the brandished angle of the bat. Furthermore, the image sensor having low resolution does not have high frame rate, and thus the image sensor cannot determine the accurate coordinate of a fast moving object.

Accordingly, there exists a need for a device for motion tracking capable of resolving the above-mentioned disadvantages.

### SUMMARY OF THE INVENTION

It is an object of the present invention to provide a device for motion tracking, wherein the device includes at least one object for reflecting light, the object includes first and second reflecting patterns with different shapes, and the coordinates of the first and second reflecting patterns are identified by reflecting the infrared light to an optical signal transmitting/receiving unit, thereby achieving the function for measuring the angle variation and displacement for the detected object.

In order to achieve the above objectives, the present invention provides a device for motion tracking including at least one object for reflecting light, an optical signal transmitting/receiving unit and a calculating/processing unit. The object includes a surface, a first reflecting pattern and a second reflecting pattern, wherein the first reflecting pattern and the second reflecting pattern are respectively located on the surface, and the first reflecting pattern is different from the second reflecting pattern. The optical signal transmitting/receiving unit transmits infrared light and receives the infrared light reflected by the object so as to form a plurality of pixel signals. The calculating/processing unit is electrically connected to the optical signal transmitting/receiving unit for calculating and processing the correlative pixel signals.

Rotated angle of the object of the present invention can be measured by the optical signal transmitting/receiving unit is within 359 degrees respectively in counterclockwise and clockwise directions. Displacement, velocity and direction of the object of the present invention can be measured by the optical signal transmitting/receiving unit. Whether the object of the present invention is moved backward or forward can be identified by the optical signal transmitting/receiving unit.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1a is a perspective schematic view of a soccer game apparatus according to the prior art.

FIG. 1b is a perspective schematic view of a signal outputting device of the soccer game apparatus according to the prior art.

FIG. 2 is a perspective schematic view of a baseball game apparatus according to the prior art.

FIG. 3 is a perspective schematic view of a device for motion tracking according to an embodiment of the present invention, showing an interactive game apparatus of an automobile race.

FIG. 4 is a cross sectional schematic view of an optical signal transmitting/receiving unit and a steering wheel object of the interactive game apparatus of an automobile race in accordance with the present invention.

FIG. 5a is a plan schematic view of the steering wheel object of the interactive game apparatus of an automobile race in accordance with the present invention.

FIG. 5b is a plan schematic view of a long bar-shaped pattern and a dot-shaped pattern of the steering wheel object of the interactive game apparatus of an automobile race in accordance with the present invention.

FIGS. 6a to 6f are plan schematic views respectively show that the rotated angle of the long bar-shaped pattern of the steering wheel object 130 is 0, 90, 120, 180, 270 and 359 degrees in the counterclockwise direction.

FIGS. 7a to 7f are plan schematic views respectively show that the rotated angle of the dot-shaped pattern and a part of the long bar-shaped pattern of the steering wheel object 130 is 0, 90, 120, 180, 270 and 359 degrees in the clockwise direction.

FIGS. 8a to 8c are plan schematic views respectively show that the dot-shaped pattern and the long bar-shaped pattern of the steering wheel object is located intermediately, moved rightward and moved leftward.

FIGS. 9a to 9c are plan schematic views respectively show that the dot-shaped pattern and the long bar-shaped pattern of the steering wheel object is located intermediately, moved backward and moved forward.

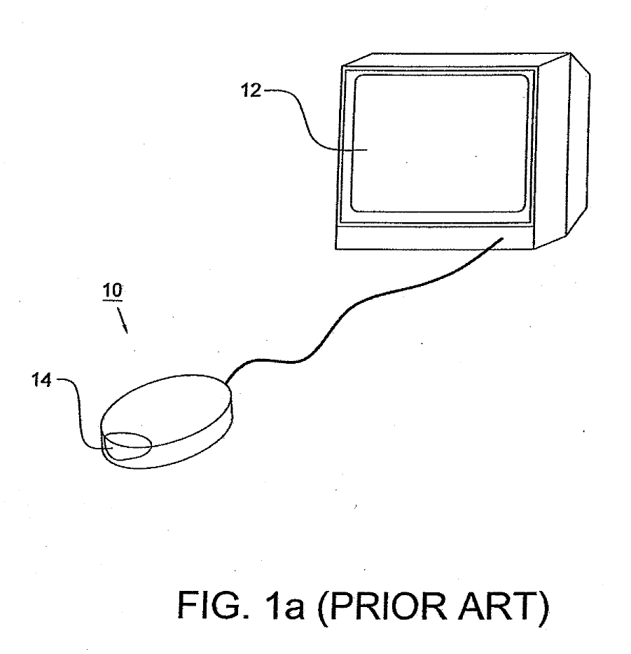

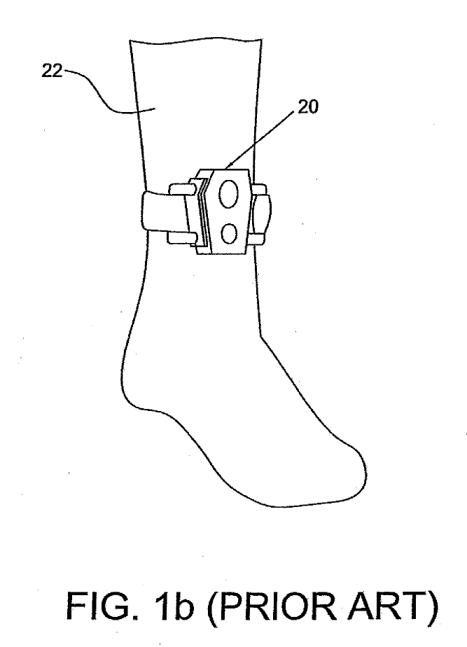

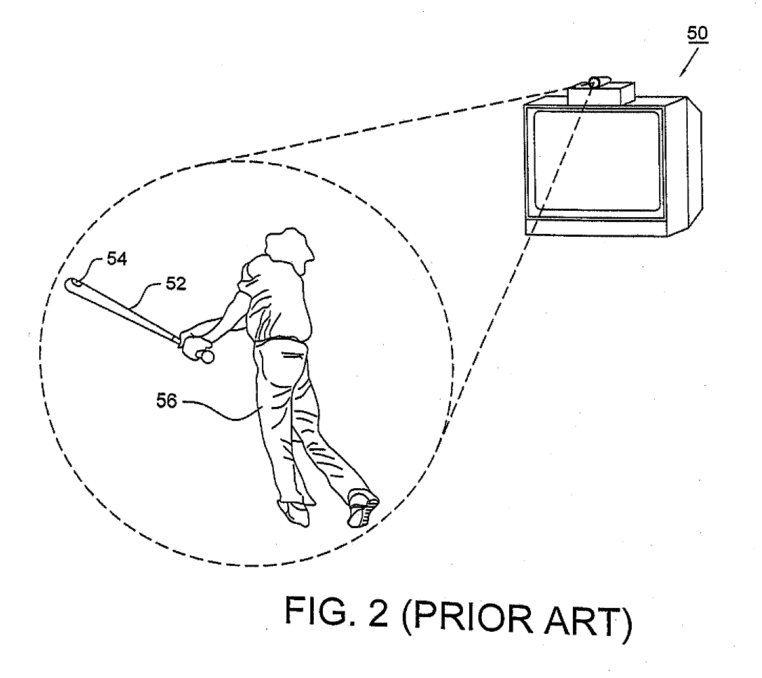

### DESCRIPTION OF THE EMBODIMENT

A device of the present invention for motion tracking can be interactive game apparatus, such as game apparatus of an automobile race, flight vehicle, ship, baseball, fencing, golf, badminton, tennis, table tennis, etc.

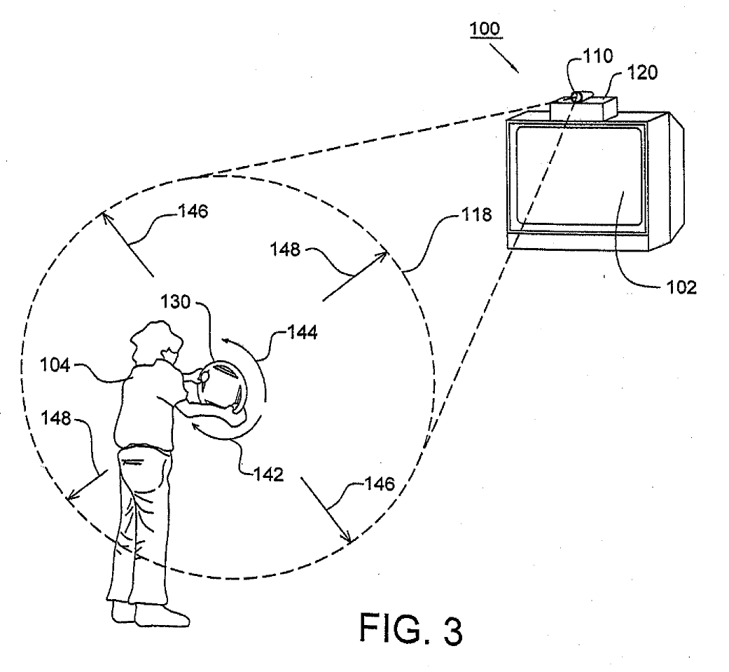

Referring to FIG. 3, it depicts a device for motion tracking according to an embodiment of the present invention. For example, the device for motion tracking according to the embodiment is an interactive game apparatus of an automobile race, as described below. An automobile race game apparatus 100 includes an optical signal transmitting/receiving unit 110, a calculating/processing unit 120, at least one object 130 for reflecting light and a screen 102. The object 130 for reflecting light according to the embodiment is a steering wheel object 130. The optical signal transmitting/receiving unit 110 transmits an infrared light to the steering wheel object 130, then the steering wheel object 130 reflects the infrared light, and finally the optical signal transmitting/receiving unit 110 receives the infrared light reflected by the steering wheel object 130, thereby forming a plurality of pixel signals. The optical signal transmitting/receiving unit 110 is electrically connected to the calculating/processing unit 120, and transmits the pixel signals to the calculating/processing unit 120. The calculating/processing unit 120 includes a universal asynchronous receiver/transmitter (UART) interface (not shown) which is electrically connected to the optical signal transmitting/receiving unit 110. The calculating/processing unit 120 further includes a calculator and a processor for respectively calculating and processing the correlative pixel signals. The automobile race game apparatus 100 receives the pixel signals formed by the infrared signals, whereby the calculating/processing unit 120 processes the correlative pixel signals so as to cause the racing car to be changed on screen 102.

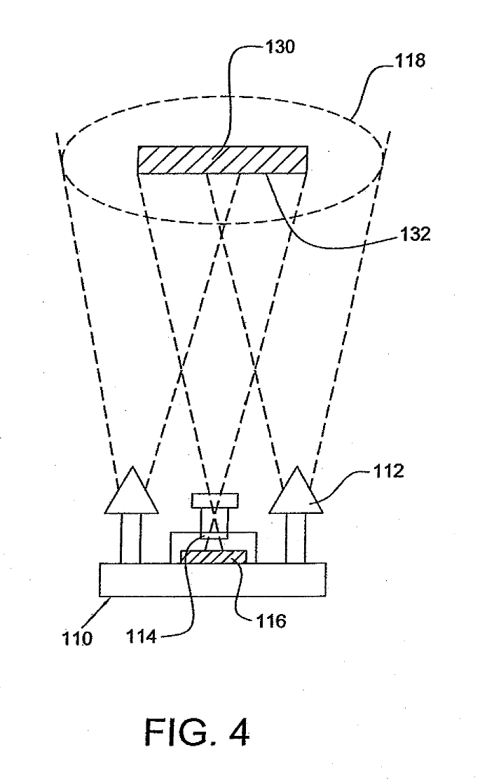

Referring to FIG. 4, more detailed, the optical signal transmitting/receiving unit 110 can include an infrared generator 112, an infrared filter (I/R filter) 114 and an image sensor 116. The infrared light generator 112 includes at least one infrared light emitting diode (I/R LED), which emits an infrared light for defining an infrared light region 118. The image sensor 116 can be a motion tracking sensor, and has a high frame rate. When the steering wheel object 130 is located in the infrared light region 118, the steering wheel object 130 can reflect the infrared light to the infrared filter 114, and then the infrared filter 114 filters out other light, whereby the image sensor 116 receives the infrared light reflected by the steering wheel object 130 so as to form a plurality of pixel signals. The image sensor 116 can be a complementary metal-oxide semiconductor (CMOS) or a charge coupled device (CCD).

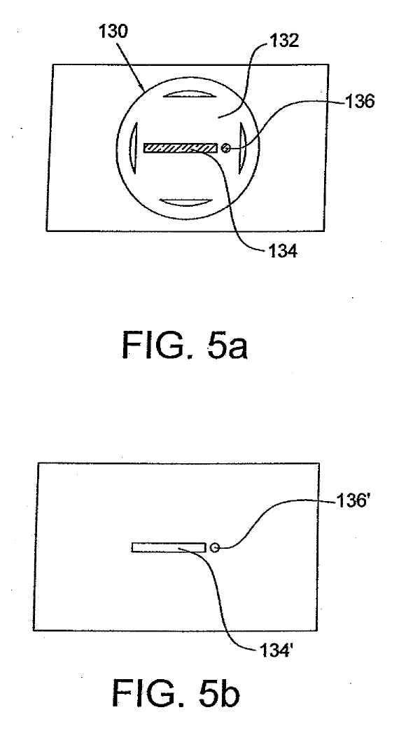

Referring to FIG. 5a, the steering wheel object 130 includes a surface 132, a first reflecting pattern 134 and a second reflecting pattern 136. The first reflecting pattern 134 and the second reflecting pattern 136 are located on the surface 132 in different location. The first and second reflecting patterns 134, 136 must be of different shapes such that they can be identified by the image sensor 116. “Different shapes” herein includes two patterns of a similar shape with different areas, or two patterns of dissimilar shapes. For example, the first and second reflecting patterns 134, 136 can be dot-shaped patterns with different areas. Preferably, the first reflecting pattern 134 can be a long bar-shaped pattern, and the second reflecting pattern 136 can be a dot-shaped pattern. The first and second reflecting patterns 134, 136 include reflective material, e.g. reflective material which meets the requirement of EN471 of European Conformity.

Referring to FIGS. 3 and 5a again, a player 104 holds the steering wheel object 130 located in the infrared light region 118. The steering wheel object 130 is firstly positioned, and the first and second reflecting patterns 134, 136 are exampled as below respectively by a long bar-shaped pattern and a dot-shaped pattern. When the infrared light emitting diode emits an infrared light, the steering wheel object 130 reflects the infrared light to the image sensor 116. The shape of the reflected infrared light in the image sensor 116 is shown in FIG. 5b. The infrared filter 114 filters the out visible light, and thus the image sensor 116 only identifies a long bar-shaped pattern 134′ and a dot-shaped pattern 136′. The long bar-shaped pattern 134′ and the dot-shaped pattern 136′ must be confirmed to face the image sensor 116. The long bar-shaped pattern 134′ and the dot-shaped pattern 136′ face the image sensor 116, and thus both the rotated angle and moved direction of the following steering wheel object 130 are based on a line of vision of the image sensor 116.

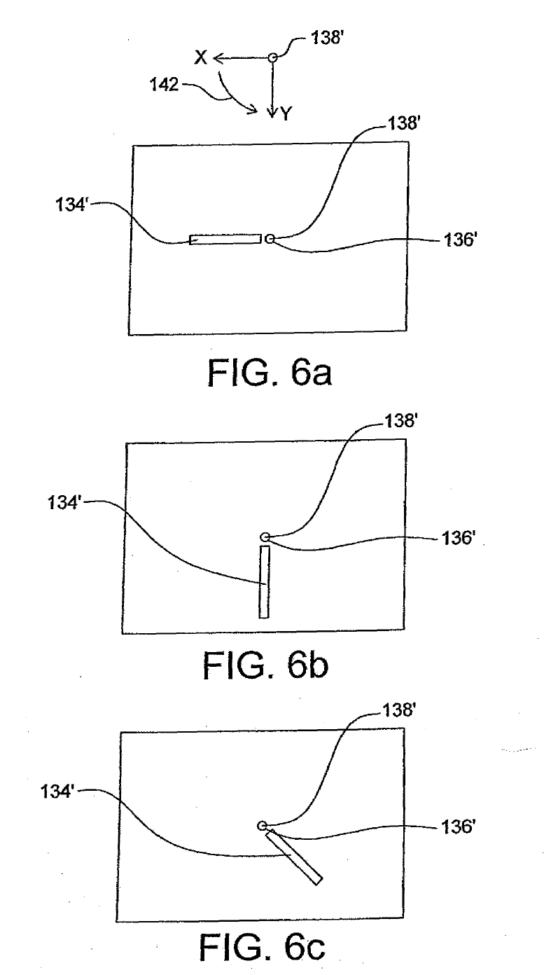

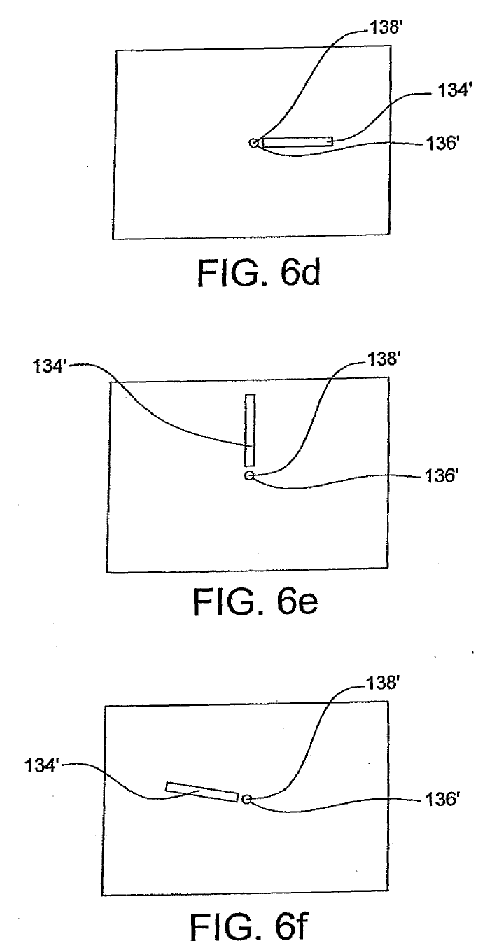

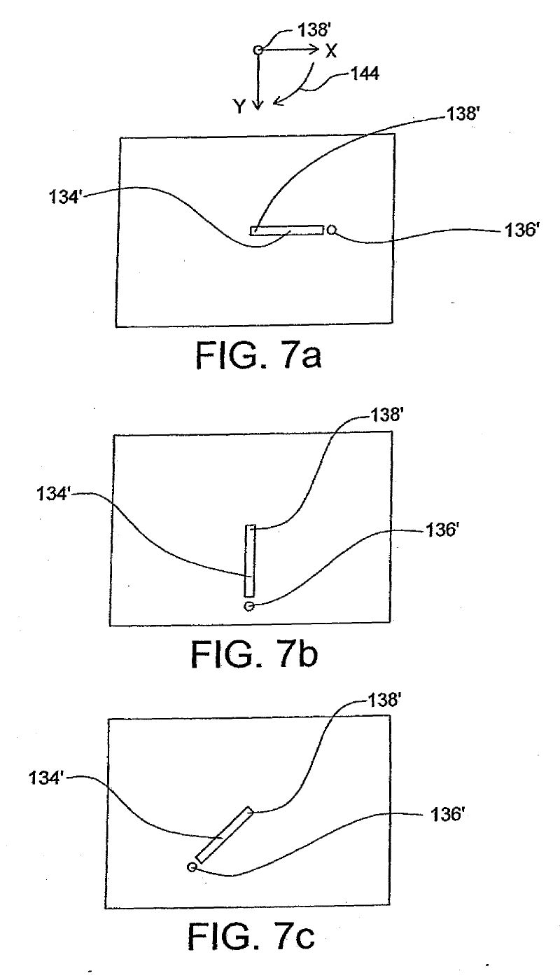

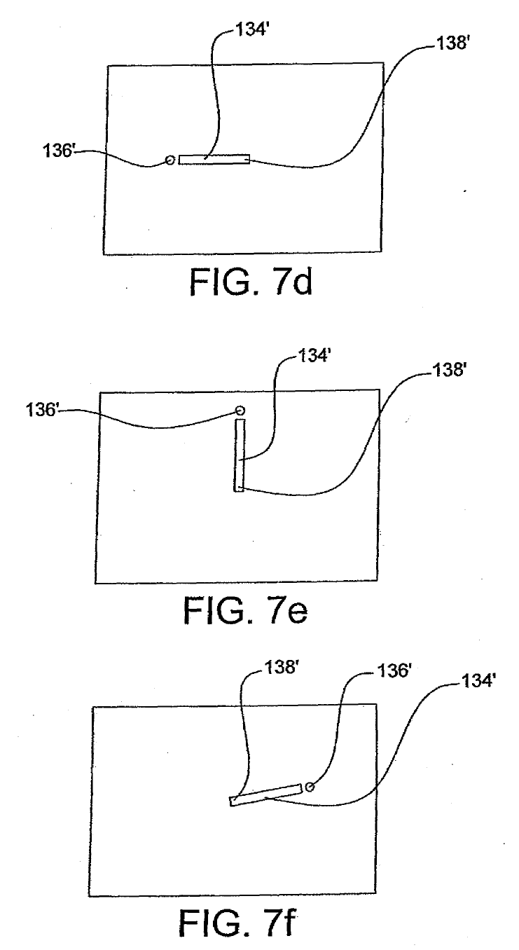

Referring to FIG. 3 again, when the steering wheel object 130 is rotated in counterclockwise direction (shown as arrow 142), the image sensor 116 can measure the rotated angle of the steering wheel object 130. In other words, the rotated angle of the steering wheel object 130 within 359 degrees in counterclockwise direction can be determined by comparing XY coordinate of reflective shape of the long bar-shaped pattern 134′ with the dot-shaped pattern 136′ acted as coordinate of positioned point. As shown in FIGS. 6a to 6f, they respectively depict that the rotated angle of the long bar-shaped pattern 134′ of the steering wheel object 130 is 0, 90, 120, 180, 270 and 359 degrees in counterclockwise direction. Furthermore, referring to FIG. 3 again, when the steering wheel object 130 is rotated in clockwise direction (shown as arrow 144), the image sensor 116 can measure the rotated angle of the steering wheel object 130. In other words, the rotated angle of the steering wheel object 130 within 359 degrees in clockwise direction can be determined by comparing XY coordinate of reflective shape of the dot-shaped pattern 136′ and a part of the long bar-shaped pattern 134′ with one end of the long bar-shaped pattern 134′ acted as coordinate of positioned point. As shown in FIGS. 7a to 7f, they respectively depict that the rotated angle of the dot-shaped pattern 136′ and a part of the long bar-shaped pattern 134′ of the steering wheel object 130 is 0, 90, 120, 180, 270 and 359 degrees in clockwise direction. Thus, the rotated angle of the steering wheel object of the present invention measured by the image sensor is within 359 degrees respectively in counterclockwise and clockwise direction.

Comparing with the prior art, the steering wheel object of the present invention has the following advantages. The steering wheel object 130 is not required to be mounted on the game apparatus, but it achieves the function of identifying the rotated angle within 359 degrees respectively in counterclockwise and clockwise direction (i.e. the total rotated angle which is identified can be 718 degrees). Besides, it is unnecessary to attach any signal outputting device on the steering wheel object.

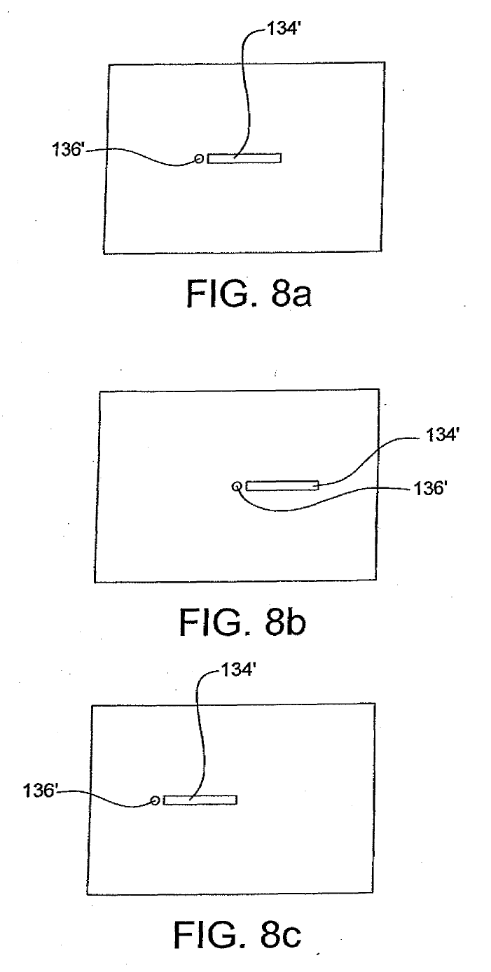

Furthermore, referring to FIG. 3 again, when the steering wheel object 130 is moved rightward or leftward (shown as arrow 146), the image sensor 116 can measure the displacement, velocity and direction of the steering wheel object 130. The image sensor 116 is a motion tracking sensor and has a high frame rate, and thus the image sensor 116 can determine an accurate coordinate of the fast moving object 130 and can output signals of the coordinate to the processor. The processor compares the signals of the coordinate with one another, thereby determining the displacement, velocity and direction of the steering wheel object 130. As shown in FIGS. 8a to 8c, they respectively depict the dot-shaped pattern 136′ and the long bar-shaped pattern 134′ of the steering wheel object 130 located intermediately, moved rightward and moved leftward. Thus, the displacement, velocity and direction of the steering wheel object 130 of the present invention can be measured by the image sensor 116.

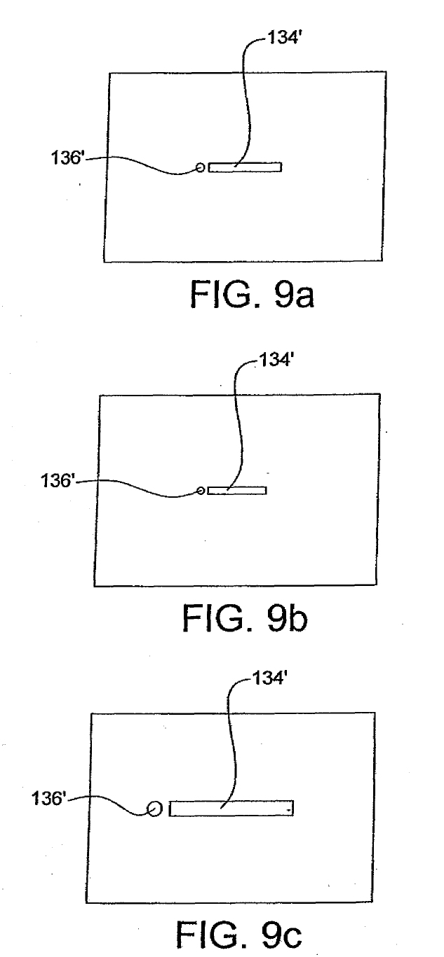

In addition, referring to FIG. 3 again, when the steering wheel object 130 is moved backward or forward (shown as arrow 148), the image sensor 116 can identify that the steering wheel object 130 is moved backward or forward. The original size of the steering wheel object 130 can be preset to be an initial value, e.g. 20 pixels of the long bar-shaped pattern 134′ of the steering wheel object 130 outputted by the image sensor 116 can be preset to be zero as the initial value. When the steering wheel object 130 is moved backward (i.e. the object 130 goes far from the image sensor 116), the size of the long bar-shaped pattern 134′ is gradually small. Accordingly, if the pixel number of the long bar-shaped pattern 134′ outputted by the image sensor 116 is less than the initial value (20 pixels), it can be determined that the steering wheel object 130 is moved backward (i.e. the object 130 goes far from the image sensor 116). Also, the distance that the object 130 is moved backward can simulate a value that is gradually less than the original initial value (20 pixels). Furthermore, if the pixel number of the long bar-shaped pattern 134′ outputted by the image sensor 116 is more than the initial value (20 pixels), it can be determined that the steering wheel object 130 is moved forward (i.e. the object 130 goes near to the image sensor 116). Also, the distance that the object 130 is moved forward can simulate a value that is gradually more than the original initial value (20 pixels). As shown in FIGS. 9a to 9c, they respectively depict the dot-shaped pattern 136′ and the long bar-shaped pattern 134′ of the steering wheel object 130 located intermediately, moved backward and moved forward. Thus, whether the steering wheel object 130 of the present invention is moved backward or forward can be identified by the image sensor 116. Furthermore, the size of an image changed by means of the steering wheel object 130 which is moved backward or forward can be determined to be different action, such as braking or accelerating.

In conclusion, the motion tracking sensor of the present invention is adapted to identify the first and second reflecting patterns with different area, such as the long bar-shaped pattern and the dot-shaped pattern, thereby achieving the function of non-contact method. In other words, the coordinates of the first and second reflecting patterns are identified by reflecting the infrared light to the image sensor, thereby achieving the function of measuring the rotated angle and the displacement, and further replacing the correlative object of the conventional steering wheel, etc., which needs to measure the accurate angle. Furthermore, as the processing capacity of the processor is gradually increased, and a plurality of players can simultaneously hold a plurality of steering wheels to play the same automobile race.

The device of the present invention for motion tracking can be other interactive game apparatus, such as game apparatus of flight vehicle, ship, baseball, fencing, golf, badminton, tennis, table tennis, etc., thus the steering wheel object of the present invention can be replaced with flight control rod, rudder, bat, sword, golf club, badminton racket, tennis racket, table tennis racket, etc. of the interactive game apparatus.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A device for motion tracking, the device comprising:
at least one object for reflecting light comprising a surface, a first reflecting pattern and a second reflecting pattern, wherein the first reflecting pattern and the second reflecting pattern are of different shapes and respectively located on the surface in different positions;
an optical signal transmitting/receiving unit adapted to transmit infrared light and receive the infrared light reflected by the object so as to form a plurality of pixel signals; and
a calculating/processing unit electrically connected to the optical signal transmitting/receiving unit for calculating and processing the correlative pixel signals.

2. The device as claimed in claim 1, wherein the first reflecting pattern and the second reflecting pattern are of a similar shape with different areas.

3. The device as claimed in claim 1, wherein the first reflecting pattern and the second reflecting pattern are of dissimilar shapes.

4. The device as claimed in claim 2, wherein the first reflecting pattern is a long bar-shaped pattern and the second reflecting patterns is a dot-shaped pattern.

5. The device as claimed in claim 1, wherein the first and second reflecting patterns include reflective material.

6. The device as claimed in claim 5, wherein the reflective material meets the requirement of EN471 of European Conformity.

7. The device as claimed in claim 1, wherein rotated angle of the object measured by the optical signal transmitting/receiving unit is within 359 degrees respectively in counterclockwise and clockwise directions.

8. The device as claimed in claim 1, wherein the optical signal transmitting/receiving unit includes a motion tracking sensor having a high frame rate.

9. The device as claimed in claim 1, wherein the displacement, velocity and direction of the object are measured by the optical signal transmitting/receiving unit.

10. The device as claimed in claim 1, wherein the object which is moved backward or forward is identified by the optical signal transmitting/receiving unit.

11. The device as claimed in claim 1, wherein the device for motion tracking is an interactive game apparatus.

12. The device as claimed in claim 11, wherein the interactive game apparatus is selected from the group consisting of game apparatus of an automobile race, flight vehicle, ship, baseball, fencing, golf, badminton, tennis and table tennis.

13. The device as claimed in claim 12, wherein the object is selected from the group consisting of steering wheel, flight control rod, rudder, bat, sword, golf club, badminton racket, tennis racket and table tennis racket.

14. A object adapted for reflecting infrared light and being used in an interactive device for motion tracking, the object comprising:
a surface;
a first reflecting pattern located on the surface; and
a first reflecting pattern and a second reflecting pattern, wherein the first reflecting pattern and the second reflecting pattern are of different shapes and respectively located on the surface in different positions.

15. The object as claimed in claim 14, wherein the first reflecting pattern and the second reflecting pattern are of a similar shape with different areas.

16. The object as claimed in claim 14, wherein the first reflecting pattern and the second reflecting pattern are of dissimilar shapes.

17. The object as claimed in claim 16, wherein the first reflecting pattern is a long bar-shaped pattern and the second reflecting patterns is a dot-shaped pattern.

18. The object as claimed in claim 14, wherein the first and second reflecting patterns include reflective material.

19. The object as claimed in claim 18, wherein the reflective material meets the requirement of EN471 of European Conformity.

20. The object as claimed in claim 14, wherein the object is applied to an interactive game apparatus.

21. The object as claimed in claim 20, wherein the interactive game apparatus is selected from the group consisting of game apparatus of automobile race, flight vehicle, ship, baseball, fencing, golf, badminton, tennis and table tennis.

22. The object as claimed in claim 21, wherein the object is selected from the group consisting of steering wheel, flight control rod, rudder, bat, sword, golf club, badminton racket, tennis racket and table tennis racket.
